(19) United States
(12) Patent Application Publication
(10) Pub. No.: US 2020/0411966 A1
(43) Pub. Date: Dec. 31, 2020

(54) RADIATOR, ANTENNA AND BASE STATION

(71) Applicant: AAC Technologies Pte. Ltd., Singapore city (SG)

(72) Inventors: Jianpeng Zhu, Shenzhen (CN); Hua Jiang, Shenzhen (CN); Lulong Li, Shenzhen (CN)

(21) Appl. No.: 16/993,310

(22) Filed: Aug. 14, 2020

Related U.S. Application Data
(63) Continuation of application No. PCT/CN2019/094038, filed on Jun. 30, 2019.

(51) Int. Cl. H01Q 1/24; H01Q 1/48; H01Q 9/04

(52) U.S. Cl. CPC H01Q 1/246; H01Q 9/0407; H01Q 1/48

(57) ABSTRACT

The present invention relates to the field of communication technology, and particularly, to a radiator, an antenna and a base station. The radiator includes a radiating body and a radiating branch. The radiating body is provided with a body hollow region, the radiating branch is located in the body hollow region, and the radiating branch and the radiating body are electrically connected. The antenna adopts the above radiator. The base station employs the above antenna. The radiator, the antenna and the base station of the present invention have advantages of small size and good radiation effect.

### TECHNICAL FIELD

The present invention relates to the field of communication technology, and particularly, to a radiator, an antenna and a base station.

### BACKGROUND

The fifth-generation mobile communication technology (5G) will greatly change our lifestyles and promote continuous advance of the society. In order to adapt to future 5G technical features such as high-speed, low latency and high capacity, the base stations will also adopt more large-scale array antennas, and thus higher requirements are raised for antenna vibrators, and miniaturized antenna radiators will be greatly developed. However, the miniaturization of the existing antennas will definitely sacrifice the radiation effect thereof to some extent.

Therefore, in order to solve the above problem, it is necessary to provide a radiator having a small size and a good radiation effect.

### SUMMARY

An object of the present invention is to provide a radiator having a small volume and a good radiation effect, an antenna and a base station.

The technical solution of the present invention is as follows:

The present invention provides a radiator, the radiator being applied to an antenna and configured to radiate electromagnetic waves, the radiator comprising: a radiating body provided with a body hollow region; and a radiating branch electrically connected to the radiating body and located in the body hollow region.

As an improvement, the radiating branch and the radiating body are located on the same plane.

As an improvement, the radiating body comprises a right triangle portion, two extending portions extending from two right-angled edges of the right triangle portion in directions facing away from a right angle of the right triangle portion, and an L-shaped connecting portion connecting the two extending portions, and the radiating body has an outer contour of a square or rectangular shape.

As an improvement, the radiating branch comprises a branch conductive region and a branch hollow region provided in the branch conductive region, and the branch conductive region is electrically connected to a middle part of the L-shaped connecting portion.

As an improvement, each of the branch conductive region and the branch hollow region is right triangle, and a right angle of the branch conductive region is electrically connected to the middle part of the L-shaped connecting portion.

The present invention further provides an antenna, comprising a first vibrator unit and a second vibrator unit that are orthogonal in a polarization manner. The first vibrator unit comprises a first radiating portion; the first radiating portion comprises a radiating substrate, and a first radiator and a second radiator that are provided on a surface of the radiating substrate; and the first radiator and the second radiator are spaced apart from each other and arranged symmetrically to each other. The second vibrator unit comprises a second radiating portion; the second radiating portion comprises a radiating substrate that is also used as the radiating substrate of the first radiating portion, and a third radiator and a fourth radiator that are provided on the radiating substrate, and the third radiator and the fourth radiator are spaced apart from each other and arranged symmetrically to each other. A straight line where the first radiator and the second radiator are located is perpendicular to a straight line where the third radiator and the fourth radiator are located; and each of the first radiator, the second radiator, the third radiator and the fourth radiator is the radiator as described above.

As an improvement, the first vibrator unit further comprises a first feeding portion configured to feed power for the first radiating portion; the first feeding portion comprises a first feeding substrate, a first ground provided on one surface of the first feeding substrate, and a first microstrip wire provided on the other surface of the first feeding substrate; and the radiating substrate and the first feeding substrate are perpendicular to and connected to each other, the first ground is electrically connected to the first radiator and the second radiator, and the first microstrip wire is spaced apart from and coupled to the first radiator and the second radiator. The second vibrator unit further comprises a second feeding portion configured to feed power for the second radiating portion; the second feeding portion comprises a second feeding substrate, a second ground provided on one surface of the second feeding substrate, and a second microstrip wire provided on the other surface of the second feeding substrate; and the radiating substrate and the second feeding substrate are perpendicular to and connected to each other, the second ground is electrically connected to the third radiator and the fourth radiator, and the second microstrip wire is spaced apart from and coupled to the third radiator and the fourth radiator.

As an improvement, the first radiator, the second radiator, the third radiator and the fourth radiator are located on the same surface of the radiating substrate; the first radiator and the second radiator are symmetrical to each other with respect to a first symmetry-axis, the third radiator and the fourth radiator are symmetrical to each other with respect to a second symmetry-axis, the first symmetry-axis is perpendicular to the second symmetry-axis, each of the first radiator and the second radiator of the first vibrator unit has an axisymmetric structure with respect to the second symmetry-axis, and each of the third radiator and the fourth radiator of the second vibrator unit has an axisymmetric structure with respect to the first symmetry-axis.

As an improvement, the antenna further includes a grounding plate. The grounding plate comprises a grounding substrate and a grounding tab fixed to a surface of the grounding substrate, the grounding substrate is connected to an end of the first feeding substrate facing away from the radiating substrate and an end of the second feeding substrate facing away from the radiating substrate, and the first ground and the second ground are both electrically connected to the grounding tab.

The present invention further provides a base station, including the antenna as described above.

Compared with the related art, in the embodiments of the present invention, the radiating body includes the radiating body provided with a body hollow region, and the radiating branch located in the body hollow region and electrically connected to the radiating body, the radiating branch can assist the radiating body to radiate, thereby enhancing the radiation effect of the first radiator without changing an outer contour of the radiating body. In this way, a size of the first radiator is reduced without affecting the radiation effect, thereby satisfying the requirements for miniaturization.

### BRIEF DESCRIPTION OF DRAWINGS

FIG. 1 is a structural perspective view of an antenna provided by an embodiment of the present invention;

FIG. 2 is a structural perspective view of a first vibrator unit provided by an embodiment of the present invention;

FIG. 3 is a structural perspective view of a first radiating portion provided by an embodiment of the present invention;

FIG. 4 is a structural perspective view of a first radiator provided by an embodiment of the present invention;

FIG. 5 is a structural exploded view of a first feeding portion provided by an embodiment of the present invention;

FIG. 6 is a structural perspective view of a second vibrator unit provided by an embodiment of the present invention;

FIG. 7 is a structural perspective view of a second radiating portion provided by an embodiment of the present invention;

FIG. 8 is a structural exploded view of a second feeding portion provided by an embodiment of the present invention;

FIG. 9 is a structural schematic diagram of a first vibrator unit and a second vibrator unit provided by an embodiment of the present invention;

FIG. 10 is a structural exploded view of a grounding plate provided by an embodiment of the present invention; and

FIG. 11 is a schematic diagram illustrating a relationship between a voltage standing wave ratio and a frequency of an antenna provided by an embodiment of the present invention.

### DESCRIPTION OF EMBODIMENTS

In order to clarify objects, technical solutions and advantages of the present invention, the present invention will be described in detail with reference to the accompanying drawings and embodiments. It should be understood that the specific embodiments described herein are only used to explain the present invention, but are not intended to limit the present invention. Based on the embodiments of the present invention, other embodiments obtained by those skilled in the art without paying creative efforts shall fall within the protection scope of the present invention.

The terms “first”, “second”, “third”, “fourth”, etc. (if present) in the description, and claims and the above accompany drawings of the present invention are used to distinguish similar objects and are not necessarily used to describe a specific order or sequence. It should be understood that numbers used in this way can be interchanged under appropriate circumstances so that the embodiments described herein can be implemented in an order other than what is illustrated or described herein. In addition, the terms “including” and “comprising” and any variations thereof are intended to cover non-exclusive inclusions. For example, processes, methods, systems, products, or devices that include or comprise a series of steps or units are not necessarily limited to those steps or units that are clearly listed, and instead, they may include other steps or units that are not explicitly listed but are inherent to these processes, methods, products or equipment.

It should be noted that the descriptions related to “first”, “second”, etc. in the present invention are for descriptive purposes only, and cannot be understood as indicating or implying their relative importance or implicitly indicating the number of technical features indicated. Thus, features defined as “first” and “second” may explicitly or implicitly include at least one of the features. In addition, the technical solutions of the various embodiments can be combined with each other, as long as those skilled in the art consider the combination implementable. When the technical solutions contradicts to each other or cannot be achieved in combinations, the combinations of these technical solutions shall neither exist, nor fall within the protection scope claimed by the present invention.

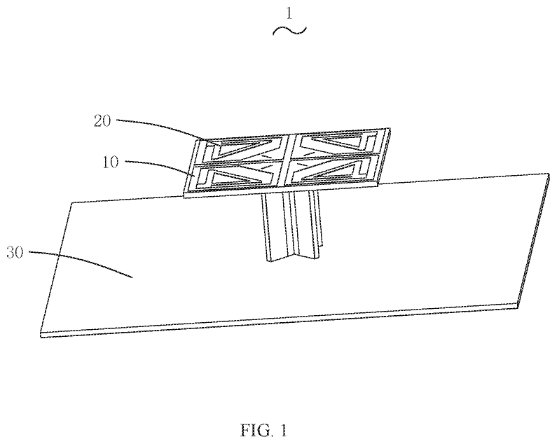

Referring to FIG. 1, the present invention provides an antenna 1. The antenna 1 includes a grounding plate 30, a first vibrator unit 10, and a second vibrator unit 20. The first vibrator unit 10 is orthogonal to the second vibrator unit 20 in a polarization manner. The grounding plate 30 is connected to the first vibrator unit 10 and the second vibrator unit 20 at the same time.

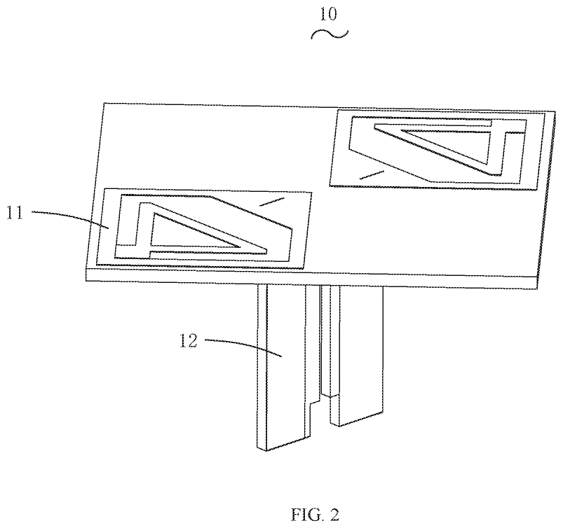

Referring to FIG. 2, the first vibrator unit 10 includes a first radiating portion 11, and a first feeding portion 12 configured to feed power for the first radiating portion 11, and the first radiating portion 11 is connected to the grounding plate 30 through the first feeding portion 12. i.e., the first feeding portion 12 is located between the first radiating portion 11 and the grounding plate 30.

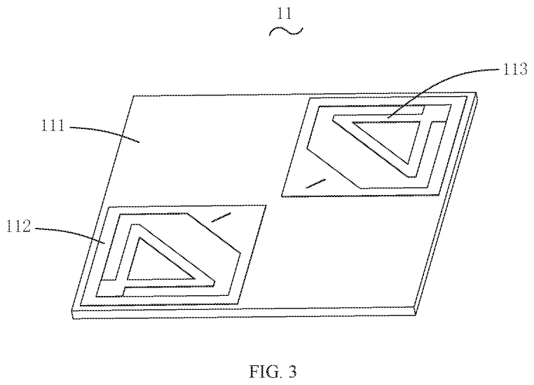

Referring to FIG. 3, the first radiating portion 11 includes a radiating substrate 111, and a first radiator 112 and a second radiator 113 that are disposed on the radiating substrate 111. The first radiator 112 and the second radiator 113 are spaced apart from each other and arranged symmetrically to each other. Both the first radiator 112 and the second radiator 113 are provided on a surface of the radiating substrate 111 facing away from the grounding plate 30. The radiating substrate 111, the first radiator 112, and the second radiator 113 are all connected to the first feeding portion 12.

A shape of the radiating substrate 111 is not limited, and it can be set as needed. In the present embodiment, the shape of the radiating substrate 111 is square.

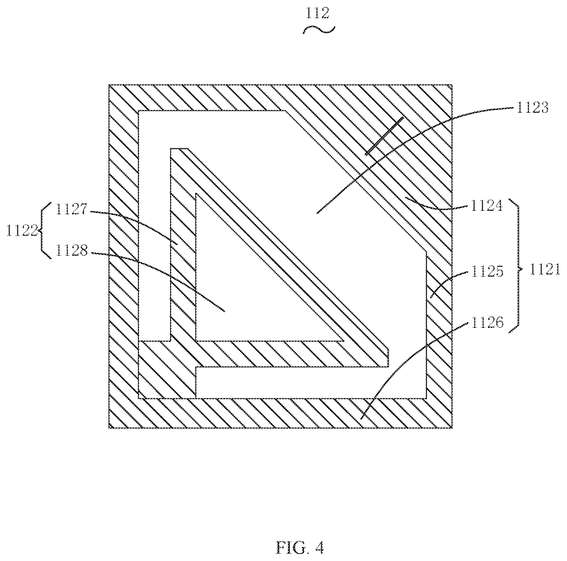

Referring to FIG. 4, the first radiator 112 can radiate electromagnetic waves, the first radiator 112 includes a radiating body 1121 and a radiating branch 1122. The radiating body 1121 is provided with a body hollow region 1123, the radiating branch 1122 is located in the body hollow region 1123, and the radiating branch 1122 is electrically connected to the radiating body 1121. Preferably, when the radiating branch 1122 and the radiating body 1121 are located on the same plane, the radiation effect is better. The radiating branch 1122 can assist the radiating body 1121 to radiate, thereby enhancing the radiation effect of the first radiator 112 without changing an outer contour of the radiating body 1121. i.e., a size of the first radiator 112 is reduced without changing the radiation effect, thereby satisfying the requirements for miniaturization.

The radiating body 1121 includes a right triangle portion 1124, two extending portions 1125 extending from two right-angled edges of the right triangle portion 1124 in a directions facing away from a right angle of the right triangle portion 1124, and an L-shaped connecting portion 1126 connecting the two extending portions 1125. The radiating body 1121 has a square outer contour. The right angle of the right triangle portion 1124 is located at a position close to a center of the radiating substrate 111, i.e., the position of the right angle of the right triangle portion 1124 is close to the second radiator 113. It can be understood that, by adjusting lengths of the extending portions 1125 and lengths of two edges of the L-shaped connecting portion 1126, the radiating body 1121 can also be changed to be rectangular. Such a structure of the radiating body 1121 achieve better radiation effect.

The radiating branch 1122 includes a branch conductive region 1127 and a branch hollow region 1128 provided in the branch conductive region 1127. The branch conductive region 1127 is electrically connected to the radiating body 1121. In the present embodiment, the branch conductive region 1127 is connected to an end of the radiating body 1121 facing away from the center of the radiating substrate 111, i.e., it is electrically connected to a corner at a middle part of the L-shaped connecting portion 1126, thereby enhancing the radiation effect of the radiating branch 1122. The branch conductive region 1127 and the branch hollow region 1128 are both right triangles, and a position of the right angle of the branch conductive region 1127 is electrically connected to the middle part of the L-shaped connecting portion 1126.

The second radiator 113 has the same structure as the first radiator 112, which will not be repeated again in the present embodiment. It should be noted that a position of a right angle of a right triangle portion of the second radiator 113 is close to the center of the radiating substrate 111, i.e., the position of the right angle of the right triangle portion of the second radiator 113 is close to the first radiator 112. A branch conductive region of the second radiator 113 is connected to an end of a radiating body of the second radiator 113 facing away from the center of the radiating substrate 111, i.e., the branch conductive region of the second radiator 113 is electrically connected to a position of a corner at a middle part of an L-shaped connecting portion of the second radiator 113.

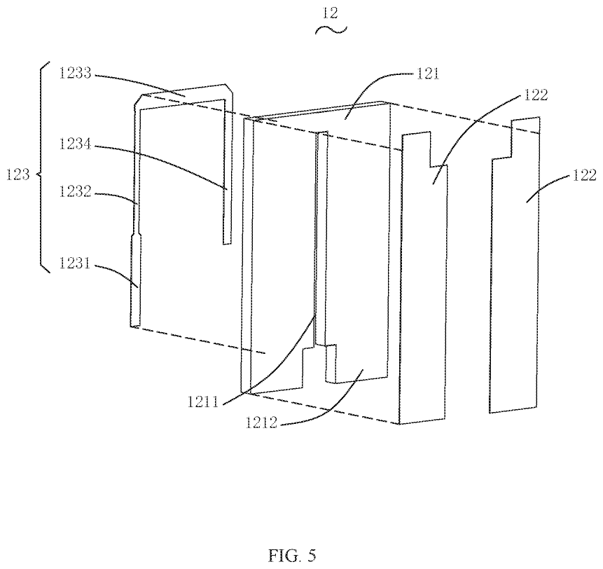

Referring to FIG. 5, the first feeding portion 12 includes a first feeding substrate 121, and a first ground 122 and a first microstrip wire 123 that are respectively disposed on two sides of the first feeding substrate 121. One end of the first feeding substrate 121 is perpendicular to and connected to the radiating substrate 111, and the other end of the first feeding substrate 121 is perpendicular to and connected to the grounding plate 30. The first ground 122 is electrically connected to the first radiator 112, the second radiator 113, and the grounding plate 30. The first microstrip wire 123 is spaced apart from and coupled to the first radiator 112 and the second radiator 113.

The first feeding substrate 121 is substantially in a shape of a cuboid. The first feeding substrate 121 is provided with a long slit 1211 configured to be connected to and engaged with the second vibrator unit 20. A first protrusions 1212 is provided on the end of the first feeding substrate 121 connected to the grounding plate 30, and the first protrusion 1212 may be inserted into and thus connected to the grounding plate 30. Two first protrusions 1212 are provided.

The first ground 122 can penetrate the radiating substrate 111 to be electrically connected to the first radiator 112 and the second radiator 113. In the present embodiment, two first grounds 122 are provided, and the two first grounds 122 are located on two sides of a surface on which the first grounds 122 are disposed. One of the two first grounds 122 is electrically connected to the first radiator 112 and the grounding plate 30, and the other one of the two first grounds 122 is electrically connected to the second radiator 113 and the grounding plate 30. It can be understood that it is possible that only one first ground 122 may be provided, as long as the first ground 122 can be electrically connected to the first radiator 112, the second radiator 113, and the grounding plate 30.

The first microstrip wire 123 includes a feeding port 1231 provided at an end of the first feeding substrate 121 facing away from the radiating substrate 111, a first strip wire 1232 extending from the feeding port 1231 in a direction facing towards the radiating substrate 111, a second strip wire 1233 extending from an end of the first strip wire 1232 facing away from the feeding port 1231 in a direction parallel to the radiating substrate 111, and a third strip wire 1234 extending from an end of the second strip wire 1233 facing away from the first strip wire 1232 in a direction facing away from the radiating substrate 111. It can be understood that the first microstrip wire 123 is not limited to the above structure, as long as it can transmit signals.

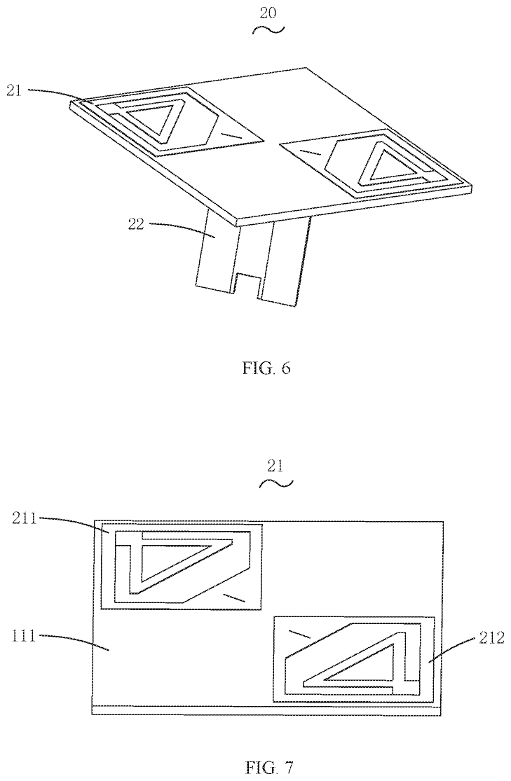

Referring to FIG. 6, the second vibrator unit 20 includes a second radiating portion 21 and a second feeding portion 22 configured to feed power for the second radiating portion 21, and the second radiating portion 21 is connected to the grounding plate 30 through the second feeding portion 22, i.e., the second feeding portion 22 is located between the second radiating portion 21 and the grounding plate 30.

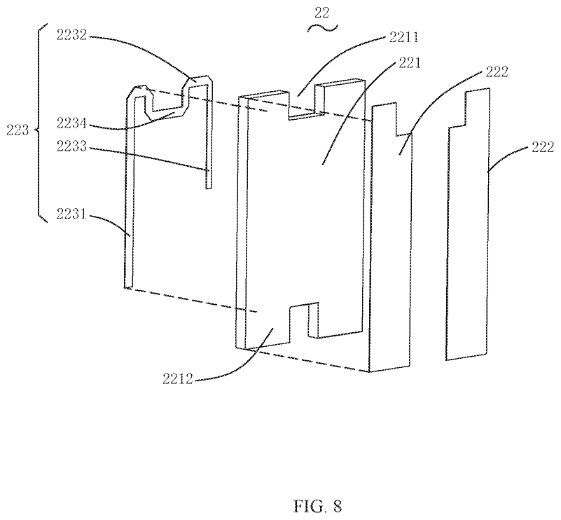

Referring to FIG. 7, the second radiating portion 21 includes a radiating substrate 111 that is also used as the radiating substrate of the first radiating portion 11, and a third radiator 211 and a fourth radiator 212 that are both provided on the radiating substrate 111. The third radiator 211 and the fourth radiator 212 are spaced apart from each other and arranged symmetrically to each other. The third radiator 211 and the fourth radiator 212 are both disposed on a surface of the radiating substrate 111 facing away from the grounding plate 30, i.e., the first radiator 112, the second radiator 113, the third radiator 211, and the fourth radiator 212 are located on the same surface of the radiating substrate 111. The radiating substrate 111, the third radiator 211, and the fourth radiator 212 are all connected to the second feeding portion 22.

The third radiator 211 has the same structure as the first radiator 112, which will not be repeated again in the present embodiment. It should be noted that a position of a right angle of a right triangle portion of the third radiator 211 is close to the center of the radiating substrate 111, i.e., the position of the right angle of the right triangle portion of the third radiator 211 is close to the fourth radiator 212. A branch conductive region of the third radiator 211 is connected to an end of a radiating body of the third radiator 211 facing away from the center of the radiating substrate 111, i.e., the branch conductive region of the third radiator 211 is electrically connected to a position of a corner of a middle part of an L-shaped connecting portion of the third radiator 211.

The fourth radiator 212 has the same structure as the first radiator 112, which will not be repeated again in the present embodiment. It should be noted that a position of a right angle of a right triangle portion of the fourth radiator 212 is close to the center of the radiating substrate 111, i.e., the position of the right angle of the right triangle portion of the fourth radiator 212 is close to the third radiator 211. A branch conductive region of the fourth radiator 212 is connected to an end of a radiating body of the fourth radiator 212 facing away from the center of the radiating substrate 111, i.e., the branch conductive region of the fourth radiator 212 is electrically connected to a position of a corner of a middle part of an L-shaped connecting portion of the fourth radiator 212. A straight line where the first radiator 112 and the second radiator 113 are located is perpendicular to a straight line where the third radiator 211 and the fourth radiator 212 are located.

Referring to FIG. 8, the second feeding portion 22 includes a second feeding substrate 221, and a second ground 222 and a second microstrip wire 223 that are respectively disposed on two sides of the second feeding substrate 221. One end of the second feeding substrate 221 is perpendicular to and connected to the radiating substrate 111, and the other end of the second feeding substrate 221 is perpendicular to and connected to the grounding plate 30. The second ground 222 is electrically connected to the third radiator 211, the fourth radiator 212, and the grounding plate 30. The second microstrip wire 223 is spaced apart from and coupled to the third radiator 211 and the fourth radiator 212.

The second feeding substrate 221 is substantially in a shape of a cuboid. The second feeding substrate 221 is provided with a short slit 2211 to be connected to and snapped with the long slit 1211 of the first feeding substrate 121 of the first vibrator unit 10. The long slit 1211 and the short slit 2211 are engaged with each other, to form an orthogonal engagement-connection structure of the first vibrator unit 10 and the second vibrator unit 20. It should be noted that the orthogonal engagement of the long slit 1211 provided on the first feeding substrate 121 and the short slit 2211 provided on the second feeding substrate 221 is merely an example. Other different engagement manners may also be specifically set according to structural characteristics of the first feeding substrate 121 and the second feeding substrate 221, which are not specifically limited herein. A second protrusion 2212 is provided at an end of the second feeding substrate 221 connected to the grounding plate 30, and the second protrusion 2212 can be inserted into and thus connected with the grounding plate 30. Two second protrusions 2212 may be provided.

The second ground 222 can penetrate the radiating substrate 111 to be electrically connected to the third radiator 211 and the fourth radiator 212. In the present embodiment, two second grounds 222 are provided, and the two second grounds 222 are located on two sides of a surface on which the second grounds 222 are disposed. One of the two second grounds 222 is electrically connected to the third radiator 211 and the grounding plate 30, and the other one of the two second grounds 222 is electrically connected to the fourth radiator 212 and the grounding plate 30. It can be understood that only one second ground 222 is provided as long as the second ground 222 can be electrically connected to the third radiator 211, the fourth radiator 212, and the grounding plate 30.

The second microstrip wire 223 includes a fourth strip wire 2231 extending from an end of the second feeding substrate 221 facing away from the radiating substrate 111 in the direction facing towards the radiating substrate 111, a fifth strip wire 2232 extending from an end of the fourth strip wire 2231 close to the radiating substrate 111 in the direction parallel to the radiating substrate 111, and a sixth strip wire 2233 extending from an end of the fifth strip wire 2232 facing away from the fourth strip wire 2231 in the direction facing away from the radiating substrate 111. In the present embodiment, the fifth strip wire 2232 further includes an avoiding portion 2234 to avoid an intersection between the fifth strip wire 2232 and the second strip wire 1233. It can be understood that the second microstrip wire 223 is not limited to the above structure, as long as it can transmit signals.

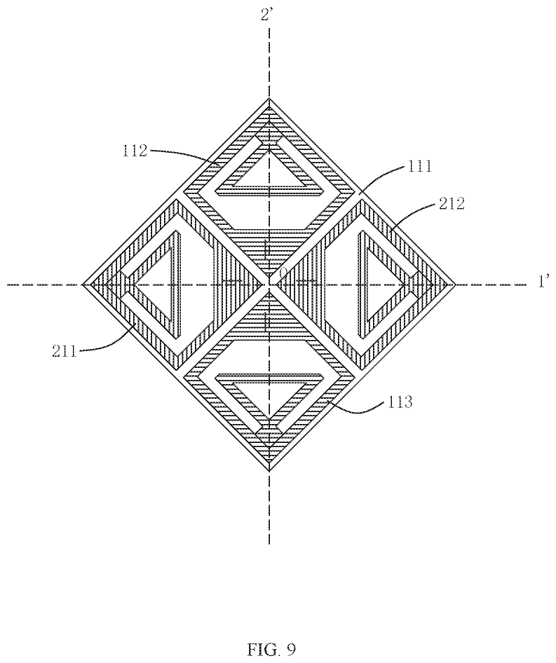

Referring to FIG. 9, the first radiator 112 and the second radiator 113 of the first vibrator unit 10 are symmetrical to each other with respect to a first symmetry-axis 1′, the third radiator 211 and the fourth radiator 212 of the second vibrator unit 20 are symmetrical to each other with respect to a second symmetry-axis 2′, and the first symmetry-axis 1′ is perpendicular to the second symmetry-axis 2′. Each of the first radiator 112 and the second radiator 113 of the first vibrator unit 10 has an axisymmetric structure with respect to the second symmetry-axis 2′, and each of the third radiator 211 and the fourth radiator 212 of the second vibrator unit 20 has an axisymmetric structure with respect to the first symmetry-axis 1′. An intersecting point of the first symmetry-axis 1′ and the second symmetry-axis 2′ is a center point O. The center point O corresponds to the center of the radiating substrate 111.

In a specific embodiment, an orthographic projection of the first feeding substrate 121 of the first vibrator unit 10 on the radiating substrate 111 overlaps the second symmetry-axis 2′, i.e., the orthographic projection of the first feeding substrate 121 on the radiating substrate 111 is located on the straight line where the first radiator 112 and the second radiator 113 are located; an orthographic projection of the second feeding substrate 221 of the second vibrator unit 20 on the radiating substrate 111 overlaps the first symmetry-axis 1′, and the orthographic projection of the second feeding substrate 221 on the radiating substrate 111 is located on the straight line where the third radiator 211 and the fourth radiator 212 are located. The first vibrator unit 10 and the second vibrator unit 20 are orthogonal in a polarization manner. For example, the first vibrator unit 10 and the second vibrator unit 20 adopt a ±45° orthogonal polarization manner, to ensure better isolation.

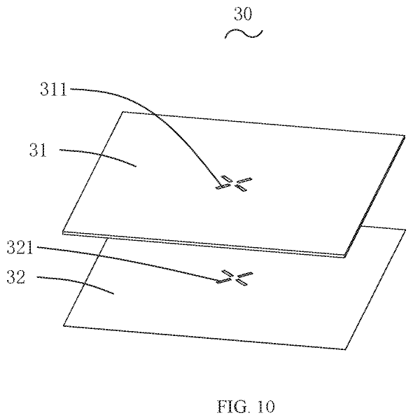

Referring to FIG. 10, the grounding plate 30 includes a grounding substrate 31 and a grounding tab 32, and the grounding tab 32 is fixed to a surface of the grounding substrate 31 facing away from the radiating substrate 111. The grounding tab 32 is configured to be grounded.

The grounding substrate 31 is provided with four connecting holes 311. The connecting holes 311 are for the fixed connection with the first feeding substrate 121 and the second feeding substrate 221. The first protrusion 1212 on the first feeding substrate 121 and the second protrusion 2212 on the second feeding substrate 221 may pass through the connecting holes 311, in order to be fixedly connected to the grounding substrate. The connecting holes 311 are also configured to allow the first ground 122 and the second ground 222 to pass through, and the first ground 122 and the second ground 222 are both connected to the grounding tab.

The grounding tab 32 is provided with four avoiding holes 321. The avoiding holes 321 are provided to allow the first protrusion 1212 and the second protrusion 2212 to pass through.

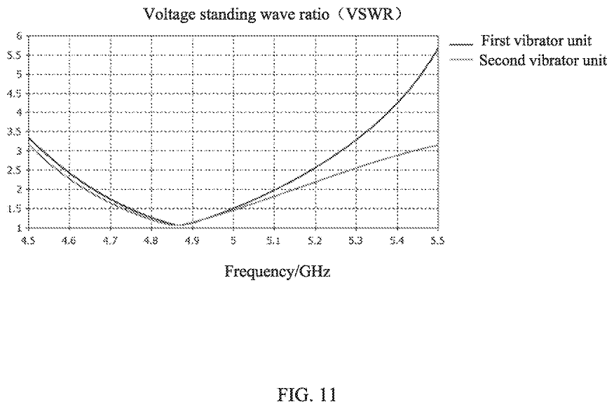

Performance of the above antenna 1 is illustrated in FIG. 11, from which it can be seen that the antenna 1 covers a frequency band of 4.8 to 5 GHz and has a relatively high gain.

It should be noted that the above are merely examples for explaining, rather than limiting the technical solutions of the present invention.

Compared with the related art, the antenna 1 designed by the present invention, although the two vibrator units intersect, the orthogonal dual polarization and high gain can be achieved, the antenna 1 has the better radiation effect with a relatively small volume, and the antenna 1 has a simple structure and a low cross-section, such that the antennas 1 can be easily arranged in an array on a base station, increasing flexibility of network coverage in the base station.

The present invention also provides a base station, and the base station includes the antenna 1 described above.

The embodiments provided by the present invention are applicable to the field of wireless mobile communication base stations and can also be applied to receiving and transmitting devices of various wireless communication systems, which are not specifically limited.

It should be noted that, the above are merely some embodiments of the present invention, those skilled in the art can make modifications without departing from the inventive concept of the present invention. However, these modifications shall not go beyond the protection scope of the present invention.

What is claimed is:

1. A radiator, the radiator being applied to an antenna and configured to radiate electromagnetic waves, the radiator comprising:
a radiating body provided with a body hollow region; and
a radiating branch electrically connected to the radiating body and located in the body hollow region.

2. The radiator as described in claim 1, wherein the radiating branch and the radiating body are located on the same plane.

3. The radiator as described in claim 1, wherein the radiating body comprises a right triangle portion, two extending portions extending from two right-angled edges of the right triangle portion in directions facing away from a right angle of the right triangle portion, and an L-shaped connecting portion connecting the two extending portions, and
wherein the radiating body has an outer contour of a square or rectangular shape.

4. The radiator as described in claim 3, wherein the radiating branch comprises a branch conductive region and a branch hollow region provided in the branch conductive region, and the branch conductive region is electrically connected to a middle part of the L-shaped connecting portion.

5. The radiator as described in claim 4, wherein each of the branch conductive region and the branch hollow region is right triangle, and a right angle of the branch conductive region is electrically connected to the middle part of the L-shaped connecting portion.

6. An antenna, comprising a first vibrator unit and a second vibrator unit that are orthogonal in a polarization manner, wherein
the first vibrator unit comprises a first radiating portion; the first radiating portion comprises a radiating substrate, and a first radiator and a second radiator that are provided on a surface of the radiating substrate; and the first radiator and the second radiator are spaced apart from each other and arranged symmetrically to each other;
the second vibrator unit comprises a second radiating portion; the second radiating portion comprises a radiating substrate that is also used as the radiating substrate of the first radiating portion, and a third radiator and a fourth radiator that are provided on the radiating substrate, and the third radiator and the fourth radiator are spaced apart from each other and arranged symmetrically to each other;
a straight line where the first radiator and the second radiator are located is perpendicular to a straight line where the third radiator and the fourth radiator are located; and
each of the first radiator, the second radiator, the third radiator and the fourth radiator is the radiator as described in claim 1.

7. The antenna as described in claim 6, wherein
the first vibrator unit further comprises a first feeding portion configured to feed power for the first radiating portion;
the first feeding portion comprises a first feeding substrate, a first ground provided on one surface of the first feeding substrate, and a first microstrip wire provided on the other surface of the first feeding substrate; and
the radiating substrate and the first feeding substrate are perpendicular to and connected to each other, the first ground is electrically connected to the first radiator and the second radiator, and the first microstrip wire is spaced apart from and coupled to the first radiator and the second radiator; and wherein
the second vibrator unit further comprises a second feeding portion configured to feed power for the second radiating portion;
the second feeding portion comprises a second feeding substrate, a second ground provided on one surface of the second feeding substrate, and a second microstrip wire provided on the other surface of the second feeding substrate; and
the radiating substrate and the second feeding substrate are perpendicular to and connected to each other, the second ground is electrically connected to the third radiator and the fourth radiator, and the second microstrip wire is spaced apart from and coupled to the third radiator and the fourth radiator.

8. The antenna as described in claim 6, wherein the first radiator, the second radiator, the third radiator and the fourth radiator are located on the same surface of the radiating substrate;
the first radiator and the second radiator are symmetrical to each other with respect to a first symmetry-axis, the third radiator and the fourth radiator are symmetrical to each other with respect to a second symmetry-axis, the first symmetry-axis is perpendicular to the second symmetry-axis, each of the first radiator and the second radiator of the first vibrator unit has an axisymmetric structure with respect to the second symmetry-axis, and each of the third radiator and the fourth radiator of the second vibrator unit has an axisymmetric structure with respect to the first symmetry-axis.

9. The antenna as described in claim 7, further comprising a grounding plate, wherein the grounding plate comprises a grounding substrate and a grounding tab fixed to a surface of the grounding substrate, the grounding substrate is connected to an end of the first feeding substrate facing away from the radiating substrate and an end of the second feeding substrate facing away from the radiating substrate, and the first ground and the second ground are both electrically connected to the grounding tab.

10. A base station, comprising the antenna as described in claim 6.
